(19) United States
(12) Patent Application Publication
(10) Pub. No.: US 2013/0261977 A1
(43) Pub. Date: Oct. 3, 2013

(54) Method of Determining a Phase Change in a Reservoir

(71) Applicant: David Sirda Shanks, Aberdeen (GB)

(72) Inventor: David Sirda Shanks, Aberdeen (GB)

(21) Appl. No.: 13/878,490

(22) PCT Filed: Oct. 19, 2011
(86) PCT No.: PCT/GB2011/052030

§ 371 Date: May 2, 2013

(30) Foreign Application Priority Data
Oct. 21, 2010 (GB) 1017814.3

(51) Int. Cl. G01V 3/30; G01V 3/38

(52) U.S. Cl. CPC G01V 3/30; G01V 3/38
USPC 702/11; 324/324

(57) ABSTRACT

Method and apparatus to determine the relative and/or absolute position of a phase change in a fluid reservoir comprising hydrocarbons by providing a first wire in a borehole within the reservoir; providing a reference system to the first wire in the borehole; transmitting an electromagnetic signal through the first wire; detecting a detected response to the electromagnetic signal from the first wire; generating a reference response from the reference system; using the reference response to correct the detected response; and determining the phase change position using data from the corrected response. Reference systems in the form of a second wire; a transmission line and an electronic equivalent circuit simulation model; and an electrical model of the first wire and borehole, are described.

The present invention relates to hydrocarbon production and in particular, though not exclusively, the invention relates to a method for determining the position of gas/oil and/or oil/brine interfaces in an oil and/or gas producing well.

The density of most hydrocarbons is lower than that of rock or water/brine. Hydrocarbons can therefore migrate up through permeable rock before reaching an impermeable rock layer, beneath which the hydrocarbons become trapped in the form of a hydrocarbon reservoir. These reservoirs are influenced by underground water and/or brine flows. The immiscibility of oil and brine results in the formation of oil and brine layers or phases within a reservoir. The fluids present in the reservoir will typically organise with a water/brine phase below the oil phase and a gas phase above it. The volume and therefore depth of these phases varies between reservoirs. Determining the relative and absolute depth of the gas, oil and brine phases in a reservoir has a number of practical and commercial advantages.

Time Domain Reflectometry (TDR) has been used to measure fluids in tanks as described in Review of Scientific Instruments 76, 095107 (2005) entitled “Time domain reflectometry-based liquid level sensor” the contents of which are incorporated herein by reference in their entirety. In this disclosure it was demonstrated that TDR may be used to measure liquid levels in tanks. US20050083062 also describes the use of TDR in tanks and also mentioned therein is its alleged application to determine the level of fluids in wells. However the inventor of the present invention has found a number of state of the art TDR systems in wells which cast doubt on the ability of the system described in the aforementioned document to function adequately in wells, especially deep well bores where the cable system is by nature complex. The problems that the inventor of the present invention has discovered include:

(i) the temperature rise in the cable alters the propagation behaviour of the sensor cable in an unpredictable way creating uncertainty and errors in the measurement;

(ii) it may be necessary to use several types of cable to convey the sensing wires into the area of interest in the well bore, causing both junctions in the sensing system and also further unpredictable responses from the overall cable system;

(iii) in a deep well the cable will need to be conveyed on a tubing string or possibly suspended but the orientation of the sensor relative to the grounded steel casing or bore hole wall will be both variable over the length of the bore hole and extremely hard to predict;

(iv) the resolution of the measurement at the end of very long lengths of sensing cable will be poor simply due to the distance from the source of the TDR pulse;

(v) the installation process is mechanically tough and the cable is likely to sustain squeeze, and grazing damage again altering the cable characteristics in an unpredictable way;

(vi) the response from the injected pulse in a complex cable system contains both many reflections and in particular complex reflection patterns from characteristics which are close together and are very difficult to interpret; and (vii) in long cable systems the response become indistinct and it can be difficult to determine any fixed points in the cable system to provide known depth references.

WO2011/044023 describes a system, method and device may be used to monitor fluid levels in a borehole. The system includes a pulse generator to generate a pulse of electromagnetic energy to propagate along the wellbore towards a surface of the fluid, a detector to detect a portion of the electromagnetic pulse reflected from the surface of the fluid and propagated along the wellbore towards the detector, a processor to analyze detected signals to determine a level of the surface of the fluid. In an embodiment, the system includes a pump controller to control the operation of a pump located in the wellbore based on the fluid surface level. This system suffers similar disadvantages and some additional as it preferably teaches to direct the pulse through the casing or drill string.

An object of the present invention is to mitigate or solve some of the problems identified with the prior art.

According to a first aspect of the present invention, there is provided a method to determine the relative and/or absolute position of a phase change in a fluid reservoir comprising hydrocarbons, the method comprising the steps of:

(a) providing a first wire in a borehole within said reservoir;

(b) providing a reference system to the first wire in the borehole;

(c) transmitting an electromagnetic signal through the first wire;

(d) detecting a detected response to the electromagnetic signal from the first wire;

(e) generating a reference response from the reference system;

(f) using the reference response to correct the detected response; and

(g) determining the phase change position using data from the corrected response.

In this way, environmental factors together with the geometry and unwanted interfaces in the borehole, which would affect the electromagnetic signal are recognised and removed. This provides a more accurate phase change position determination as the spurious effects are removed.

In an embodiment, the reference system comprises a second wire also provided in the borehole wherein the first wire is provided in more direct contact with the surrounding environment than the second wire. Preferably, the method includes the step of transmitting the electromagnetic signal through the second wire and detecting a reference response to the electromagnetic signal from the second wire.

Preferably, the response of the second wire is deducted from the response of the first wire.

Preferably the first and second wires are used in parallel. By this it is meant that the first and second wires are arranged to be side by side but may be measured separately and independently from each other. In addition, the first and second wires are measured at the same time to provide two contemporary sets of readings of response based on environmental conditions in the well at the time of the readings.

Preferably the first and second wires are combined in a cable, the cable having a first end and a second opposite end, the cable comprising at least the first and second wire, each wire extending from the first to the second end, the first wire being only partially encapsulated within an insulating material such that in use the first wire is in electrical communication with an exposed face of the cable between the first and second ends.

The first wire may be an outer wire and the second wire may be an inner wire. Preferably, the first wire is in electrical communication with an exposed face of the cable between the first and second ends, for at least 20% of the length of the cable, preferably at least 50%, more preferably at least 90%. Preferably, the first wire is in electrical communication with an exposed face of the cable between the first and second ends essentially along the whole length of the cable. Preferably, the second wire is substantially encapsulated within the insulating material.

The cable can comprise a third conducting wire. Preferably the third conducting wire provides continuous electrical connection from the first to the second end of the cable. The third conducting wire can be used to provide electrical power to devices connected at either end of the cable. Preferably the first and/or second wire is helically wound. Preferably, each wire is insulated from other wires. More preferably the first and second wires are wound around, and insulated from, the third wire. Preferably, the first and second wires may be wound in a helix, wherein the helix for the second wire has approximately half the diameter of the helix for the first wire. Conductive material may be provided between the first wire and the surface of the cable, whilst less conductive material surrounds the second wire. For such embodiments there is no direct exposure of either wire to the environment, but the first wire is electrically connected to the surrounding environment, whereas the second wire is less electrically connected thereto, essentially insulated therefrom. Preferably, the cable is encapsulated in an insulating material and has one or more grooves running the length thereof to expose at least in part the first wire to its surrounding environment.

Preferably the cable comprises two grooves, especially on opposite sides of the cable. This groove can directly expose the first wire to its surrounding environment or the grove may comprise an insulating layer between first wire and fluid, wherein insulating layer between first wire and fluid has a lower resistance that the insulation between the second wire and fluid. The first wire may comprise outwardly extending portions to provide, in part at least, an electrical contact between the first wire and its surrounding environment. The cable may be flat or can also have a round or oval outer shape typically to allow deployment through moving seals into pressurised well bores. The second wire is preferably insulated until the end of the cable where it can be left open circuit or attached to an end termination by means of some conductive housing so that it exhibits a short circuit termination. Preferably, a further wire is helically wound around the cable to function as a protective layer. Preferably, said further wire is of a larger diameter than the first or second wires.

Preferably, the cable is semi-rigid. A semi-rigid cable is advantageous because it facilitates the entry of the cable into the well bore. This is because a semi-rigid cable is easier to push into a well bore than a fully flexible and non-rigid cable. Preferably the cable comprises carbon fibre and/or Kevlar. Carbon fibre and/or Kevlar add to the rigidity of the cable. The wires can each independently be copper, stainless steel or any other conductive material. Preferably the first and second wires are stainless steel and the third wire is copper. The cable can be surrounded by a conductive casing providing a ground return. Preferably the conductive casing is a wellbore casing. The diameter of the cable may be between 3 and 50 cm, preferably between 15 and 20 cm.

Preferably the cable comprises a range of insulation layers. Preferably, the cable comprises a number of cable sections distributed along the length of the cable. Preferably, the cable comprises a switch for switching on and off a connection between two cable sections.

Preferably, the cable comprises a plurality of terminations for electrically coupling to a wire. Preferably, the terminations comprise a first termination and a second termination, wherein the first termination has an impedance which is different to the second termination's impedance. Ideally, the cable comprises four terminations. Preferably the four terminations comprises a first and second termination located at one end of the wire and a first and second termination located at the opposite end of the wire. Preferably the cable comprises a switch for electrically coupling and decoupling a termination to and from the wire. Preferably, the terminations are located in electronic gauges mounted at the top and bottom of the wire and the switch is controlled using a separate wire contained within a conventional cable from surface. Optionally, the cable comprises a portion of increased mass to restrict movement of the section of cable which in use is lowermost in the wellbore and/or reservoir. Preferably the portion of cable with increased mass extends radially outwards from the external surface of the cable.

Preferably, the cable may be spliced or joined with a conventional cable. Preferred embodiments require more direct electrical communication of the outer wire with the surrounding environment to be provided substantially in the reservoir only. Typically the conventional cable may be run down the borehole, for example, attached to the casing or production tubing, and is joined to cable as described herein immediately above the reservoir. This reduces the cost of the cable as a shorter length is required and improves the accuracy of the method as both wires are insulated from spurious environmental conditions in the borehole above the reservoir.

In a further embodiment, the reference system comprises a transmission line and an electronic equivalent circuit simulation model. Preferably, the method includes the step of generating the reference response by obtaining an expected response of the wire using the transmission line simulation model.

Preferably the method includes determining from the transmission line simulation model the relative and/or absolute position of a phase change.

Preferably the method includes the step of calibrating the simulation model with data obtained from comparing the expected response and the detected response. Preferably, the steps of are performed iteratively until the expected response substantially agrees with the detected response. Preferably, the step of correcting the detected response comprises making a numerical correlation between the expected response and the detected response. The numerical correlation can be done by creating a simulated waveform and subtracting the live trace from the simulated one, or using a simulated pulse shape and performing time shift correlation to obtain a match. The simulation can be correlated in individual response elements, by using expected positions, from the simulation, of inflections or reflections and processing the live data to identify the true position of these responses.

Preferably, the transmission line simulation iterates the possible positions of a gas to oil phase change and an oil to brine phase change until ‘the best’ correlation between the modelled response and the detected response is obtained. This is typically done within software and numerical matching is carried out. Correlation is typically not very good and matches are poor, with 40-60% correlation.

Preferably the transmission line simulation model models amplitude, polarity, and timing of the responses from the wire due to any changes in the wire's electromagnetic characteristics.

Preferably the transmission line simulation model uses sets of mathematical algorithms and a particular set of mathematical algorithms can be selected for a particular type of wire. The simulation of the response from the wire may be performed in real time.

In a yet further embodiment, the reference system comprises an electrical model of the first wire and borehole. Preferably, the method includes the step of generating the reference response by producing a predicted response of the first wire and borehole based on known properties of the first wire and borehole.

The known properties may comprise the actual cable length, pipe diameters, conveyance cable properties, as well as the cable's inductance, capacitance, resonant behaviour, etc. In this way the correction helps isolate elements of the detected response which are due to phase changes in the fluids in the reservoir. This data can then be used to determine the relative and/or absolute position of the phase change.

Preferably, the electrical model is generated by providing a model of a circuit which is electrically equivalent to the wire and borehole. Preferably, data from the detected response is used to calibrate the electrical model.

Preferably the electromagnetic signal is transmitted at a first end of the cable and the response is detected at the first end of the cable. Transmitting an electromagnetic signal can comprise transmitting an electromagnetic pulse and detecting a response can comprise detecting a reflection of the electromagnetic pulse. Preferably, the pulse is generated by an impedance driver having an impedance of less than 100 ohms. The pulses can have an amplitude of between 5 volts and 100 volts, preferably between 5 volts and 20 volts, and especially 15 volts. The pulses may have a width of 10 nS to 100 μS and preferably two inverted responses are obtained by sending a rising edge and then a falling edge some time between 10-20 μS later. These features ensure that a pulse transmitted from one end of the cable assembly has a duration (width) and amplitude of sufficient magnitude such that the pulse reaches the other end of the cable assembly and is still detectable once reflected and received at the end of the cable from which it was initially transmitted. The rise and fall times of the pulse are under 100 nS and preferably under 10 nS.

Preferably detecting a reflection of the electromagnetic pulse comprises recording properties of the reflected electromagnetic pulse. Preferably the properties recorded include one or more of frequency, intensity, wave shape, inflections and reflections in amplitude, the times of the transmission and reflection and/or the time delay between them, pulse slope, and amplitude. Other data may also be obtained from the reflected signal, preferably conductivity data. Preferably, this other data is used to generate information as to the depth of the brine/oil boundary.

Transmitting an electromagnetic signal through a wire can also comprise creating a resonant circuit comprising the wire and detecting a response can comprise measuring the resonant circuit's frequency response. Preferably, measuring the frequency response comprises extracting the complex impedance of the wire. This can be done by methods including, but not limited to, measuring low frequency behaviour, resonant frequency behaviour, the peak amplitude and also the onset of standing wave behaviour at higher frequencies. This in turn can be used to calculate the resistance to ground and the dielectric constant of the cable system. Typical frequencies are between 100 Khz and 1 MHz but may extend to several Mhz depending on the cable length and fluids being sensed.

Preferably, transmitting an electromagnetic signal through a wire comprises both transmitting an electromagnetic pulse and creating resonant circuit comprising the wire. Preferably, the wire used for transmitting an electromagnetic pulse is also used to create a resonant circuit. Alternatively, separate wires can be provided, at least one for transmitting an electromagnetic pulse and at least another creating a resonant circuit. Preferably, the measurement of a response from the wire is windowed to focus at a time or frequency zone where a response is expected. Optionally, single or multiple frequency capacitance can be measured on the wire.

Transmitting an electromagnetic signal through a wire can also comprise applying an electrical voltage to the wire and detecting a response can comprise measuring the current that flows to earth through the wire.

Determining the position of a gas to brine phase change or an oil to brine phase change preferably includes using known cable parameters. Preferably the determination of the relative and/or absolute position of a phase change in a fluid reservoir comprising hydrocarbons is repeated a plurality of times in order to obtain readings for a point in the reservoir. Preferably the determination is repeated for a point in the reservoir between 10-1,000 times, preferably between 20-50 times and ideally 20 times. Preferably, a single electromagnetic pulse is transmitted for each repetition of the determination. Alternatively, pulses can be sent periodically.

Preferably, the method comprises determining the response of a section of a plurality of sections of wire forming the wire. Preferably determining the response of a section comprises electrically disconnecting the section from another section and measuring the response of the another section to determine a reference point for the section. Preferably, the method includes electrically connecting the section to the another section and measuring the response of the section connected to the another section and determining a reference point for the another section from the result. Preferably a switch is used to electrically connect and disconnect the sections.

Preferably, the method comprises determining the response of the wire with a termination electrically coupled to the wire. Preferably, the method includes the steps of:

(a) providing a first termination and a second termination;

(b) determining the relative and/or absolute position of a phase changein a fluid reservoir comprising hydrocarbons with the first termination electrically coupled to the wire; and

(c) determining the relative and/or absolute position of a phase change in a fluid reservoir comprising hydrocarbons with the second termination electrically coupled to the wire.

Preferably, the first termination has an impedance which is different to the second termination's impedance. Ideally, four terminations are provided. Preferably the four terminations comprise a first and second termination located at one end of the wire and a first and second termination located at the opposite end of the wire. Preferably, steps (b) and (c) are repeated a plurality of times. Preferably a switch is used to connect and disconnect the terminations to and from the wire. Preferably, the response of the wire electrically coupled to a termination with a higher impedance is deducted from the response of said same wire electrically coupled to a lower impedance termination. Preferably the responses are measured as close in time as possible so they represent the same fluid conditions. By this it is meant that the same produces a different response depending on the impedance placed to ground at any point in the cable. By placing known impedances at the top and bottom the response is altered and this alteration precisely locates the point the impedance is placed.

According to a second aspect of the present invention, there is provided an apparatus for determining the relative and/or absolute position of a phase change in a hydrocarbon reservoir, the apparatus comprising a first wire; an electromagnetic pulse generator; a detector for detecting an electromagnetic pulse; a reference signal generator; and processing means for comparing a detected signal with a reference signal and determining a position of a phase change.

Preferably, the reference signal generator is according to the first aspect.

Preferably, the apparatus includes a second wire. More preferably the first wire and the second wire are in a cable, wherein the cable is according to the features described as per the first aspect.

Embodiments of the present invention will now be described by way of example only and with reference to and as shown in the accompanying drawings, in which:

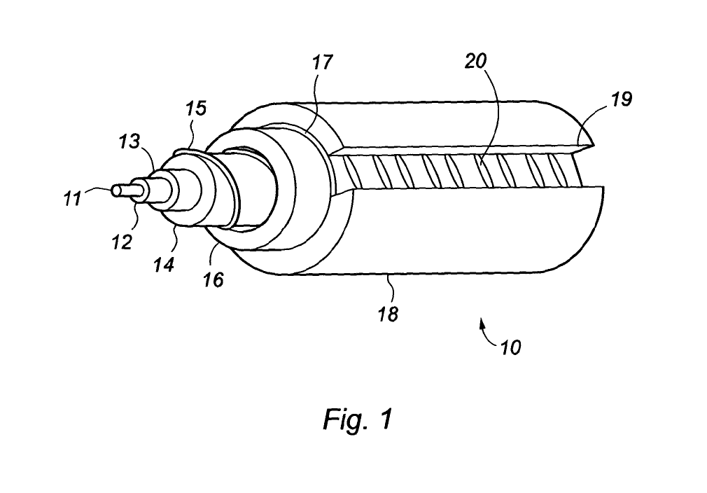

FIG. 1 is a perspective, part-sectional view of a cable according to an embodiment of the present invention;

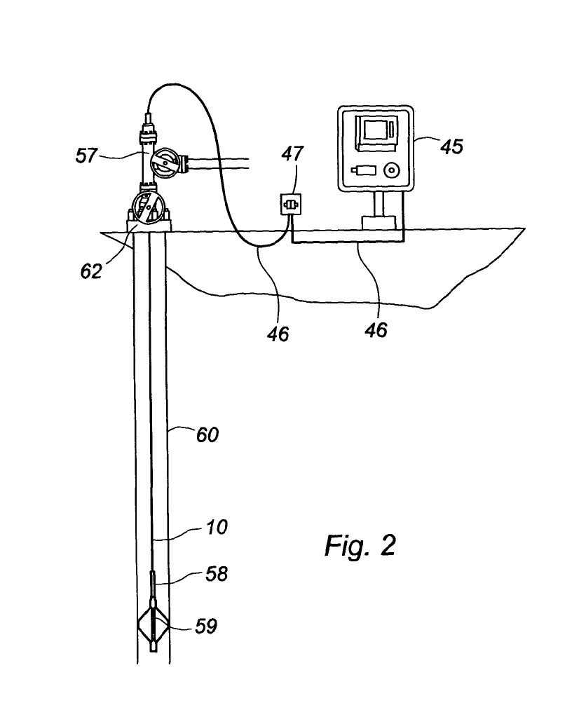

FIG. 2 is a diagrammatic, sectional view of a wellbore, downhole tubular and cable according to an embodiment of the present invention;

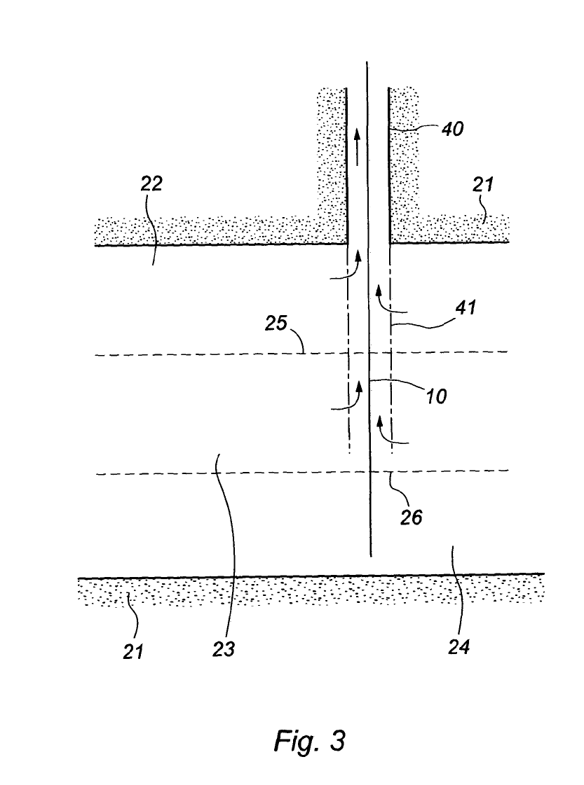

FIG. 3 is a diagrammatic representation of a hydrocarbon reservoir;

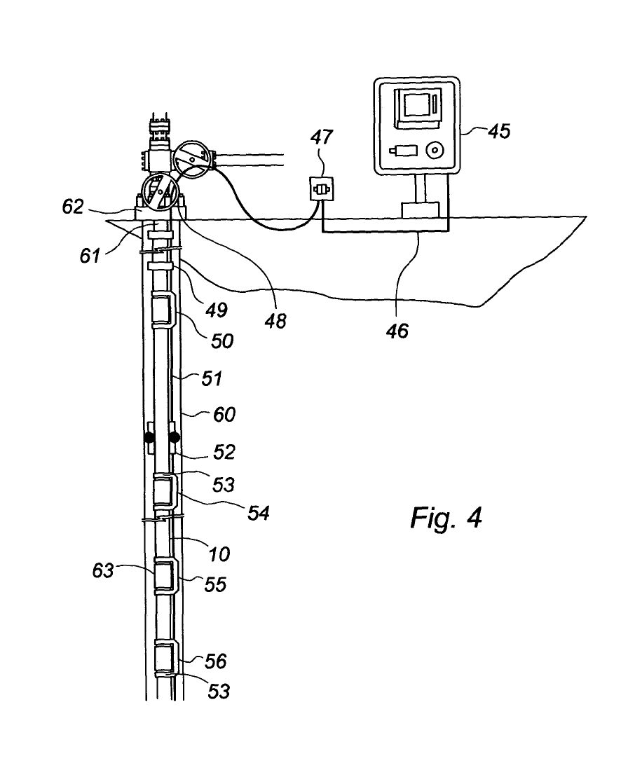

FIG. 4 is a second view of the FIG. 2 wellbore and cable along with production tubing and an electric submersible pump (EPS);

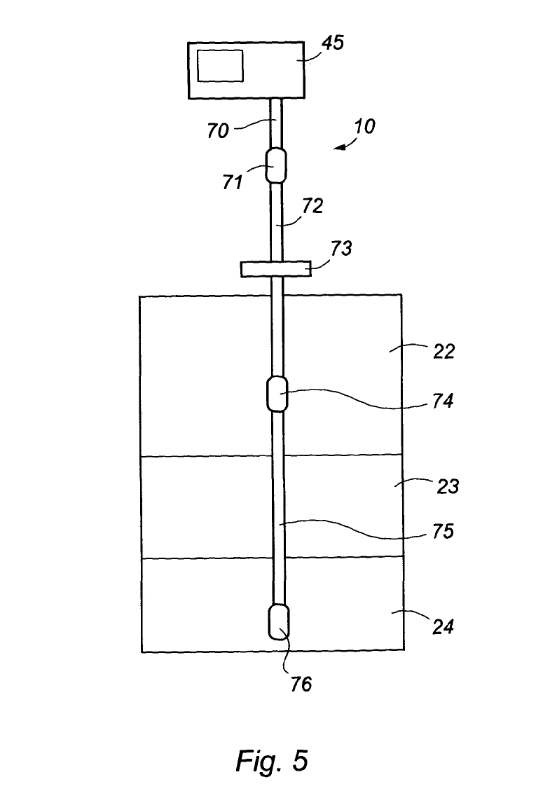

FIG. 5 shows a cable in communication with an electronics system;

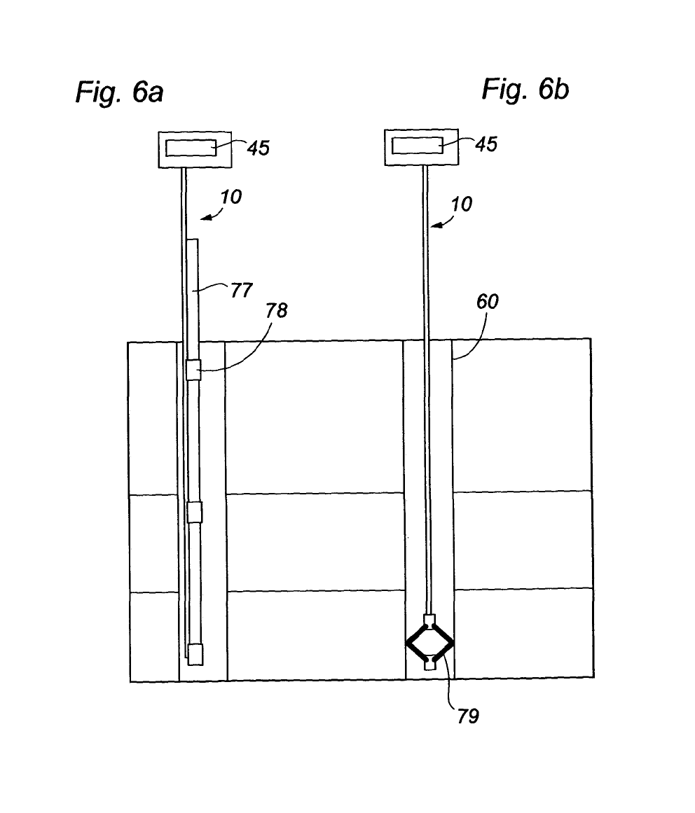

FIG. 6a shows a cable strapped to steel tubing, FIG. 6b shows the cable passing through the wellbore and being anchored to a motorised anchor;

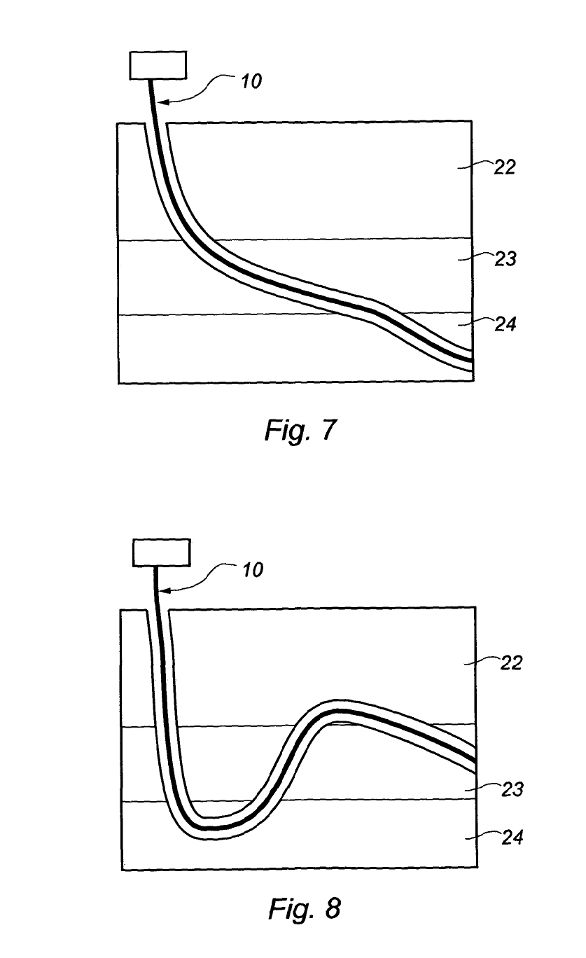

FIG. 7 shows deployment of a cable in a non-vertical well;

FIG. 8 show deployment of a cable in another non-vertical well;

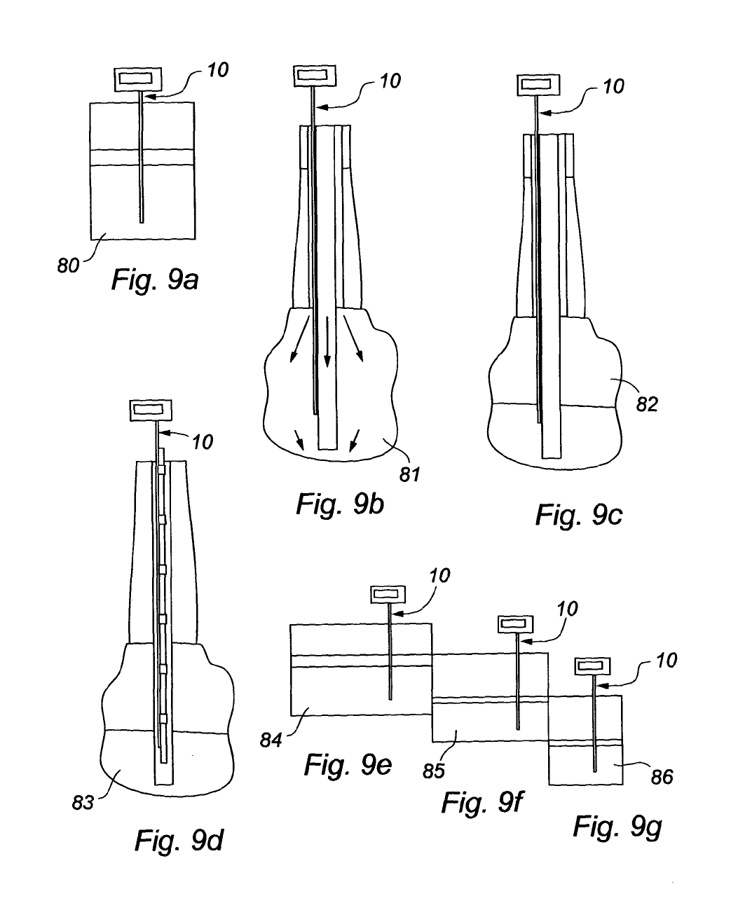

FIGS. 9A to 9G show various embodiments of the present invention;

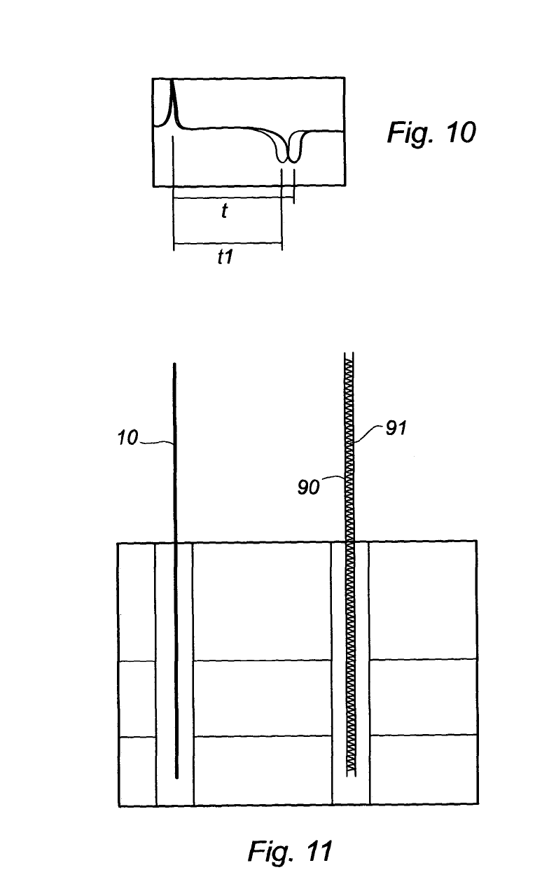

FIG. 10 shows a graph of the intensity of signal reflection against time;

FIG. 11 shows a cable in accordance with an alternative embodiment of the present invention;

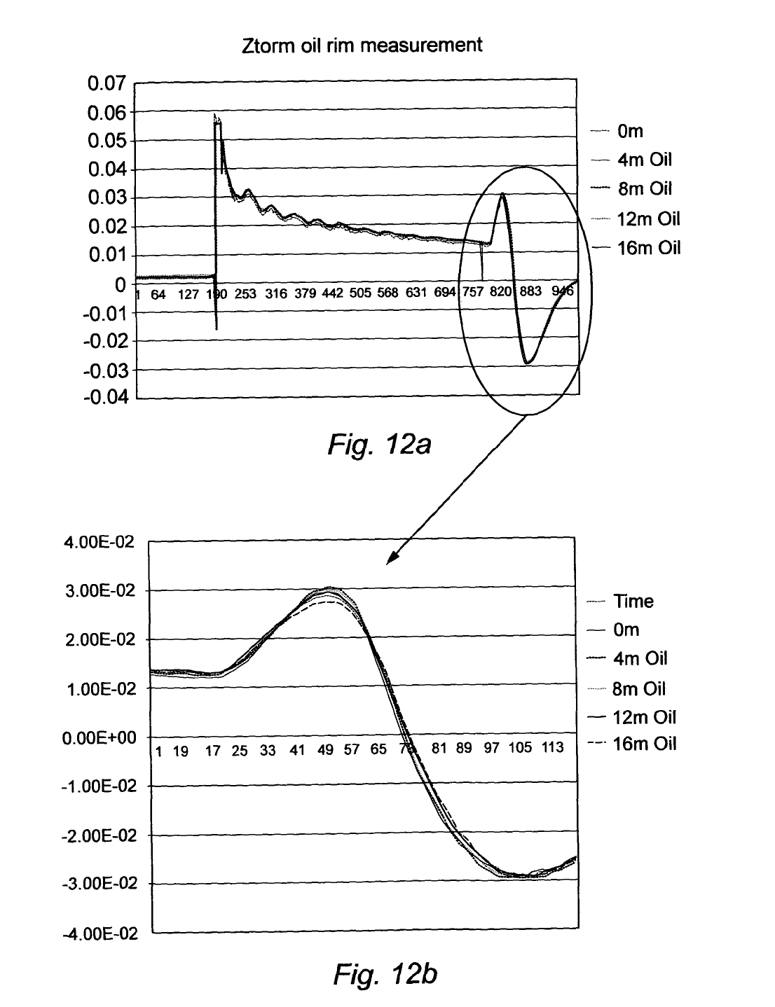

FIGS. 12a and 12b show the use a ‘windowed measurement’ technique;

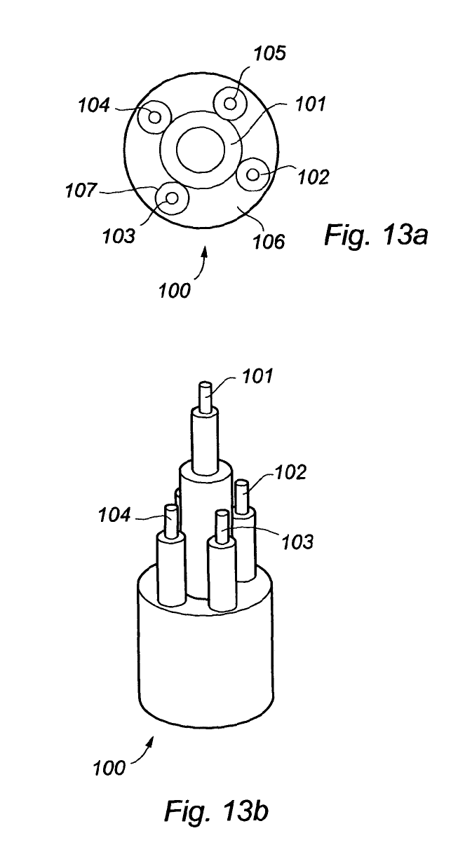

FIGS. 13a and 13b show a number of multicore cables;

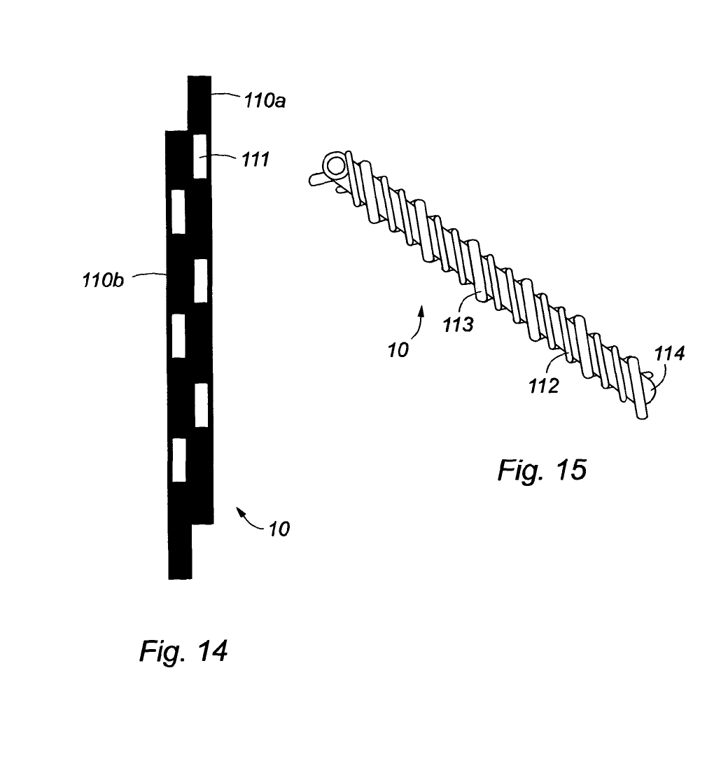

FIG. 14 shows a cable including wires with raised beads;

FIG. 15 shows a cable including a wire and bumper wire;

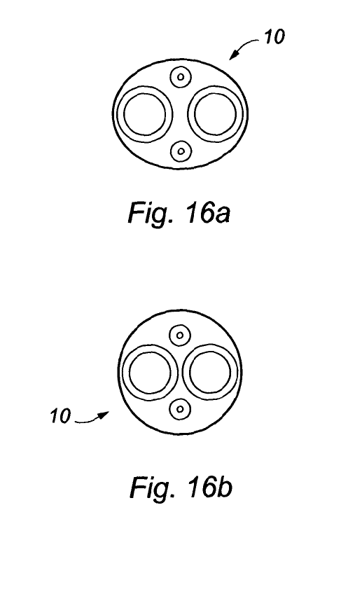

FIG. 16A shows a cable with an oval outer profile, FIG. 16B shows a cable with a round outer profile;

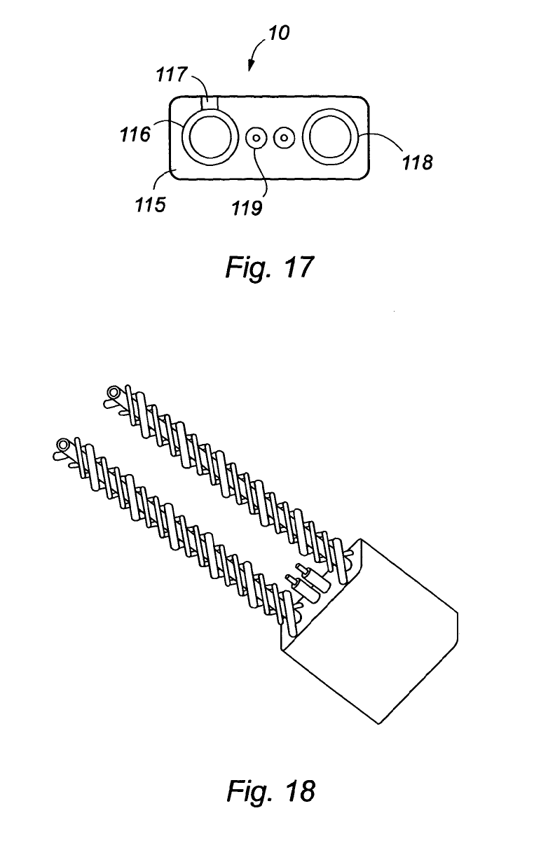

FIG. 17 shows a cable with a square outer profile;

FIG. 18 shows a perspective view of a cable shown in cross-section in FIG. 17;

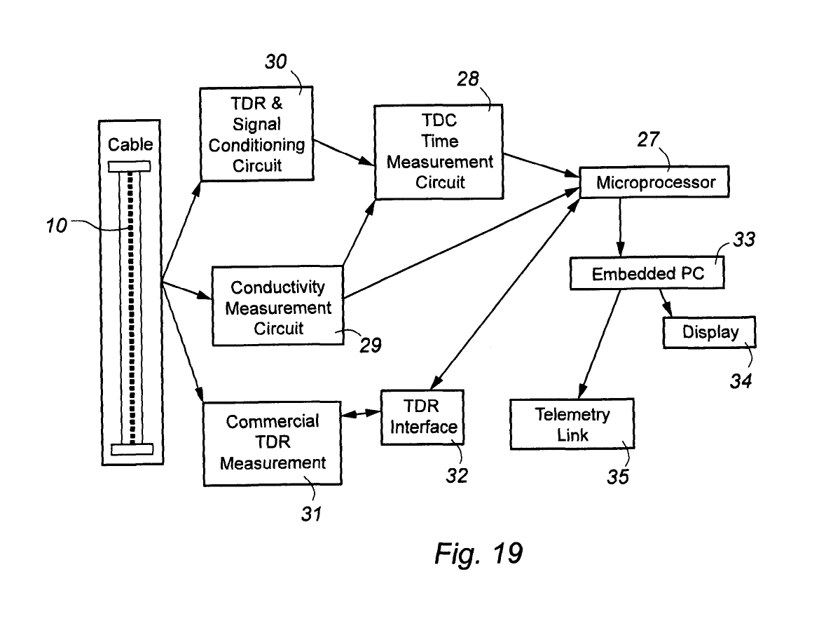

FIG. 19 is a diagrammatic representation of a method according to an embodiment of the present invention;

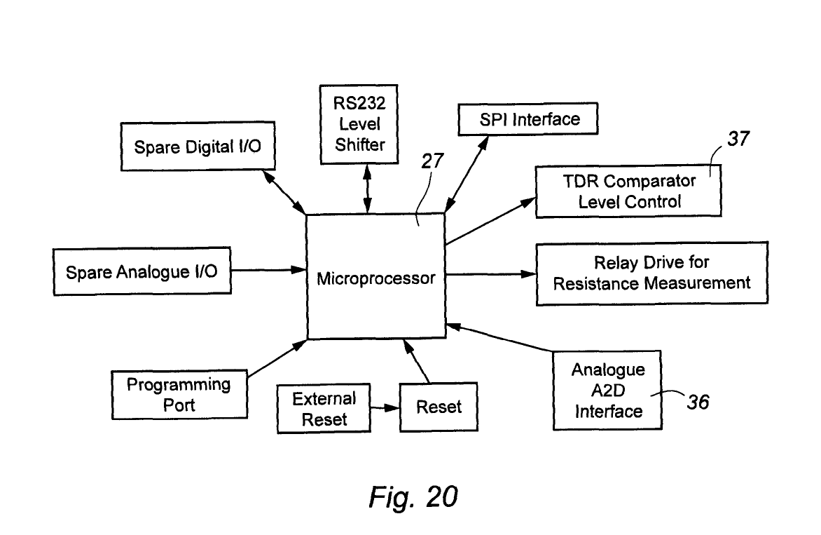

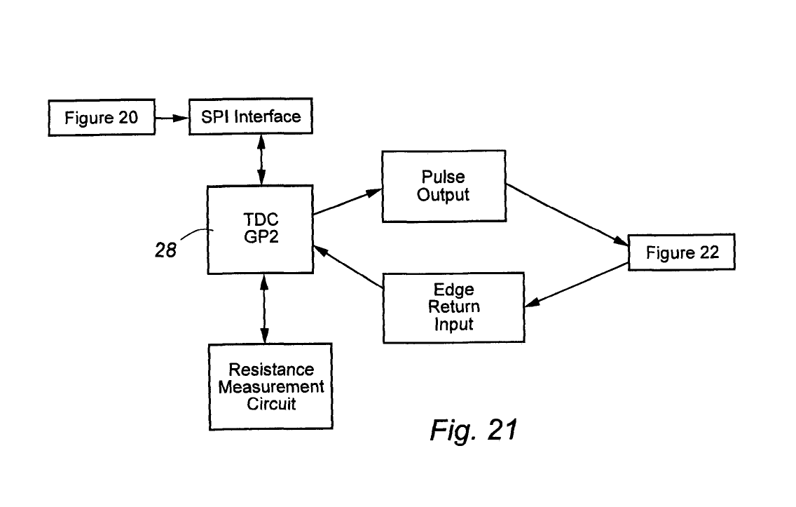

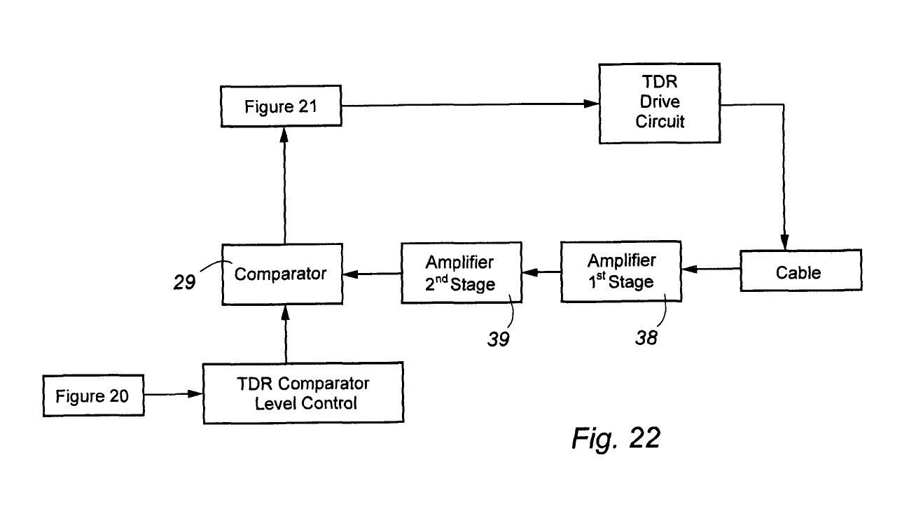

FIG. 20 is a diagrammatic representation of possible inputs and outputs to and from a microprocessor in accordance with the present invention;

FIG. 21 is a diagrammatic representation of the (TDC) time measurement circuit in accordance with the present invention;

FIG. 22 is a diagrammatic representation of a comparator in accordance with the present invention;

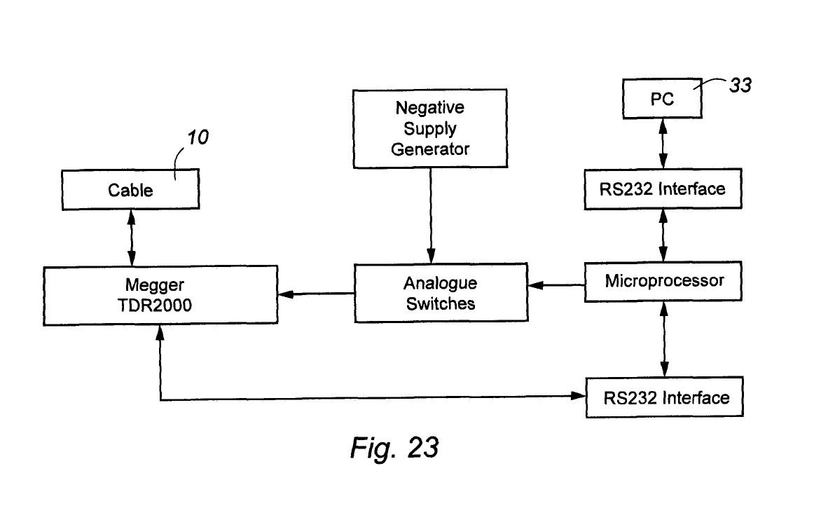

FIG. 23 is a diagrammatic representation of the Time Domain Reflectometry (TDR) interface in accordance with the present invention;

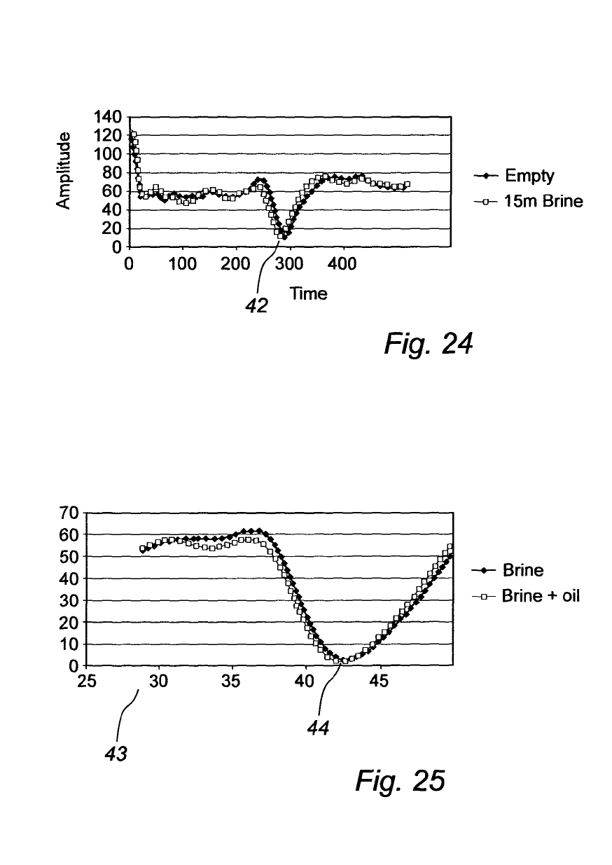

FIG. 24 is a graph of TDR measurements taken using a plastic hose with brine;

FIG. 25 is a graph of TDR measurements taken with brine only and with oil and brine;

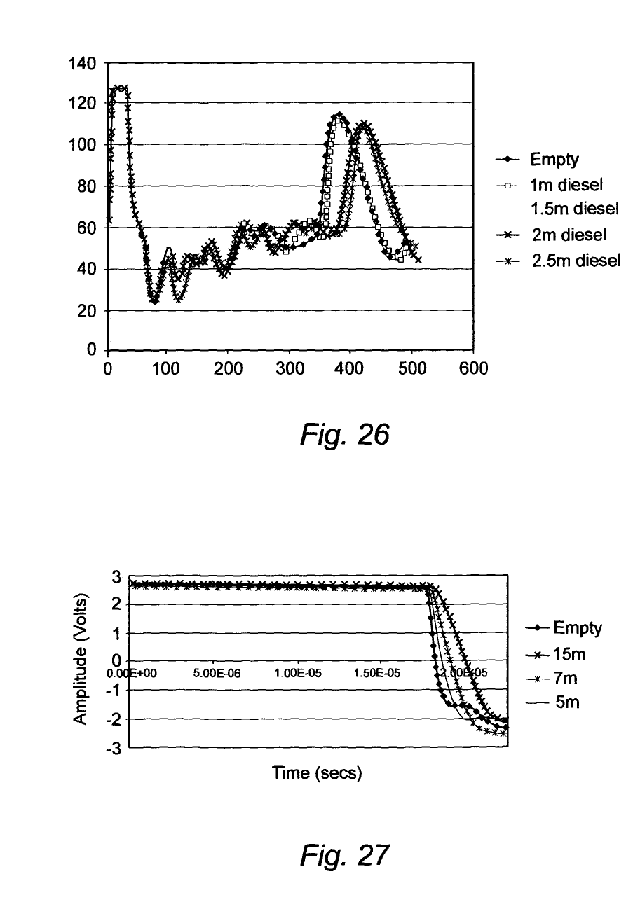

FIG. 26 is a graph of the movement of the termination return at different fluid depths; and

FIG. 27 is a graph of the recovered signal showing the effects of a brine level change.

FIG. 1 shows a cable 10 made specifically for determining the position of a phase change and comprising a first outer conducting wire 17, a second inner conducting wire 15 and a third innermost conducting wire 11. The first and second wires 17, 15 are helically wound and notably the first wire is exposed on an outer face of the cable 10 by the grooves 19.

The innermost wire 11 is encased in an insulating material 12; other layers of insulating material 13 and 14 insulate the inner wire 15 from wire 11, whilst insulating material 16 separates the inner wire 15 from the outer wire 17. An outer protective layer 18 partially, but not fully, covers the outer wire 17.

In marked contrast to conventional cables, the cable 10 of the present invention comprises a wire, the first wire 17, which is in electrical communication with an exposed face of the cable 10 between its ends i.e. in addition to the exposure of conducting elements of conventional cables at either one of two ends.

As the first outer conducting wire 17 will typically be more affected by its surroundings than the second wire 15, this allows the extraction of elements of the response from the first wire which are due to its electrical communication with its environment. In this way the effects due to, for example, temperature, cable joints, and field installed cabling at the surface, etc. can be removed. Thus a differential reading results which substantially removes the effects of cable joins and temperature and mechanical installation effects from the final length based interface measurement. Thus for such embodiments the first wire 17 is in electrical communication with an exposed face of the cable 10 because the wire is exposed on the cable 10 because of said grooves 19.

Providing the first and/or second wires 17, 15 as helically wound increases the length of the wires 17, 15 compared to the cable 10 and so increases the time for the pulses of electromagnetic radiation to travel through the cable 10. Thus more accurate results can be obtained and/or devices used to time the period between the pulse and the reflection being received back, may be less sensitive compared to those required where the wires 17, 15 are linear.

The grooves 19 in the outer layer of the cable allow the outer wire 17 to be in electrical contact with an external medium, for example brine, oil or gas. Brine conducts electromagnetic radiation; oil and gas do not.

FIG. 2 shows a diagrammatic, sectional view of a borehole 60 and cable 10 extending to a weighted centraliser 59 at the lowermost end of the wellbore 60 in accordance with an embodiment of the present invention. The cable 10 passes through a wellhead 57 and connects to a surface armoured cable 46. Optionally, the cable 10 comprises the weighted centraliser 59 to restrict movement of the section of cable 10 which in use is lowermost in the wellbore 60.

In use, the cable 10 is lowered through a borehole, such as a wellbore, into the reservoir, and supported in the casing or tubing. Alternatively, the cable can be attached to the outside of well tubing for deployment at discrete depths of the borehole and/or reservoir, with a production completion. The surface mounted armoured cable 46 passes through an Electric Submersible Pump (ESP) cable junction box 47 and provides data to a computer data logger 45. The computer data logger 45 includes a microprocessor 27 and other devices as shown in FIGS. 22 and 23, 25 described further below.

In use, the cable 10 is exposed to any fluid below the wellhead 57 and is used to determine phase change boundaries in a reservoir.

FIG. 3 shows a hydrocarbon reservoir comprising bedrock 21 and gas 22, oil 23 and brine 24 phases. The gas/oil interface is depicted at 25 and the oil/brine interface at 26. A borehole 40 extends through the bedrock 21. A wellbore casing 41 extends into the fluid reservoir and gas 22 and oil 23 are able to pass through the wellbore casing 41. Cable 10 extends from the surface, through the wellbore casing 41, contacting the gas 22, oil 23 and brine 24 phases and terminates near the bottom of the reservoir proximate to the bedrock 21. The lowermost end of the cable 10 therefore terminates in the brine phase 24. The cable 10 thus extends from the surface through the gas 22, oil 23 and brine 24 phases and terminates at a weight, such as the weighted centraliser (not shown), near to the bottom of the reservoir, proximate to the bedrock 21.

As noted above in relation to FIG. 1, the outer wire (not shown) is exposed, any reflection detected from the outer wire will typically be more affected by the environment in which the cable is provided, compared to the reflection detected from the inner wire (not shown). Indeed, taking the difference between reflection detected from the inner and outer wires can provide information on the environment of the wires since the other factors which effect the reflection will typically be the same for the inner and outer wires; the main or only difference being the more direct electrical contact of the outer wire to the surrounding environment.

When a pulse of electromagnetic energy is supplied to the outer wire (not shown) of the cable 10, the boundaries between the different phases of materials in the reservoir will impact on how the pulse signal is transmitted along the wire.

For example, the gas/oil boundary 25 causes a small reflection or an inflection. However, for a pulse passed through the outer wire, it will substantially continue within the outer wire when the cable 10 extends through the gas 22 and oil 23 phases. In addition, the speed of the pulse will vary through these phases. Data obtained from the speed of the reflected pulse can be used to determine the position of the gas/oil phase boundary.

When the pulse reaches a sharp change in the dielectric properties of the surrounding fluid or reaches the brine phase 24, it is largely transmitted through the brine 24 (i.e. short circuited) and discontinues travelling through the cable 10. This is because it is able to reach ground or earth more easily by passing through the brine compared to the wires of the cable 10. At this point a small part of the pulse is reflected back towards the first end of the cable 10 where it can be detected. Parameters can be obtained from the reflected pulse and used to determine the relative and/or absolute position of the brine/oil phase boundary 26. In particular, using the time delay between pulse transmission and detection and the characteristics of the cable 10, the position of the brine/oil phase boundary 26 along the cable 10 can be calculated.

FIG. 4 shows an alternative embodiment of the cable and borehole shown in FIG. 2.

Production tubing 61 and an Electric Submersible Pump (ESP) 63 are shown. The cable 10 is spliced with a one quarter inch multicore DH cable 51 below a packer 52. Cable 10 passes through cable protectors 55 and at the lowermost end of the cable 10 there is a multidrop gauge 56 and gauge carrier 53. The conventional cable 51 is secured to the production tubing by stainless steel bands 49 and is protected from damage by protectors 50. In use, the embodiment shown in FIG. 4 functions in the same way as the embodiment shown in FIGS. 2 and 3.

FIG. 5 shows a cable 10 in communication with an electronics system or computer data logger 45 and layers of gas 22, oil 23 and water 24. The cable comprises several sections. A first section 70 connects the electronics system 45 to a first junction box 71. A second section 72 also connects to the first junction box 71 and passes through a well head 73 to a second junction box 74. The second section 72 is a non-sensing cable. Section 72 is encased in a metal sheath so that no fluid is able to contact 15 the wires (not shown). A third section of cable 75 is “live” and is therefore in communication with the fluids in which it comes into contact. The cable 75 terminates in a third junction box 76. The electrical properties of the cable 10 may vary between the cable 20 sections 70, 72, 75. These differences in the electrical properties of the sections from which the cable 10 is formed will impact on how a signal is transmitted along the inner and outer wires. For example the use of sections can result in signals being reflected at the junction boxes 71, 72 between the sections 70, 72, 75. Therefore, a switch (not shown) is used for connecting or disconnecting one section to or from another section. This allows a section to be isolated from the section below it and the response of the section can then be determined. This response is then used as reference point for determining the response of the next section down. These reference points can be used to further remove uncertainty and allow precise compensation for length. For example, the first section 70 can be disconnected from the second section 72 at the first junction box 71. The response of the first section 70 can then be determined using an electrical pulse and used as reference point. The first section 70 can then be reconnected to the second section 72 at the first junction box 71. When a pulse is transmitted through these sections, reflections due to the connection between the first and second sections 70, 72 can be identified from the reference point.

In addition, the “live” section 75 (or indeed the previously described embodiments of the cable) can be also be made up of a number of sections. When a short circuit due to brine 24 occurs, the short circuit can be removed through disconnecting the section of the cable in which the short circuit occurs, thereby isolating the section of cable having wires reflecting a signal due to being in the brine 24 phase. This provides further correlation of the precise location of the cable termination.

The first, second and third junction boxes 71, 74 and 76 may also include instrumentation for measuring parameters such as the pressure and temperature of the surrounding fluid. Data collected by this instrumentation is relayed to the surface using spare conducting wires (not shown) in the cable 10.

In addition, a number of terminations can be provided, one termination with an impedance which is higher than another termination. By comparing the response of a wire in a borehole with a high impedance termination with that of the wire with a lower impedance termination at either the top of bottom of the cable, the position in the response of the top or bottom of the wire can be more easily determined. In addition, this method facilitates removal of features or noise in the response. The need to process the complete response is also negated as the area where the fluid interfaces occur can be clearly determined because switching impedance sections generates impedance traces which clearly define the top and bottom of a zone of interest.

In use the data obtained is used to clearly identify the ends and joints in the cable so that the response from these joints can be easily identified and not confused for fluid responses. In addition, by imposing know impedances to ground at strategic junctions the response of the total system to a typical oil or water response is demonstrated and can assist in more precise determination of the position of the fluid interface. This method can also be of benefit if one of the two sensor wires is faulty because the measurement relies on a single sensor wire.

FIG. 6a shows the cable 10 in communication with the electronics system 45 strapped to steel tubing 77 using clamps 78. FIG. 6b shows the cable 10 passing through the well bore 60 and anchored to a motorised anchor 79. In an alternative embodiment the anchor 79 is spring 25 activated. In a further alternative embodiment the anchor is a weight.

FIGS. 7 and 8 show deployment of the cable 10 in non-vertical wells. In these cases the true vertical depth of the gas, oil and brine layers are calculated using a well trajectory model. Deployment of the cables 10 in these wells is difficult and is assisted by encasing the cable 10 in a carbon fibre shell (not shown). The shell makes the cable stiff enough so that it can be pushed through the wellbore. In an alternative embodiment the cable is deployed in coiled tubing. In FIG. 8 the cable 10 is shown passing through the various layers more than once. The resultant signals are more complex compared to those obtained from a vertical well but the signals are decoded to provide useful information about the relative amounts of the various layers.

FIGS. 9A to G show various embodiments of the present invention. In FIG. 9A the cable 10 is shown passing into a tank 80 containing three fluids. In FIG. 9B the cable 10 is shown passing into an underground gas storage cavern 81. In FIG. 9C the cable 10 is shown being used to measure the ground water level in a mine 82. The cable 10 also transmits data to the surface about the purity of the water. FIG. 9D shows the cable 10 being used to measure fluid levels in an observation oil well 83. FIGS. 9E, F and G show the cable 10 used to measure the fluid levels in a separator 84, waste processing system 85 and mixed fluid handling system 86. In each case there is a layer of oily material above water.

FIG. 10 shows a graph of the intensity of signal reflection against time caused by the fluid “t”. The label “t1” indicates the effect of a change in fluid level. By using helical wires the primary measurement t1-t is increased by the same factor as the length increase caused by the helical winding.

FIG. 11 shows the cable 10 as described above and a cable 90 in accordance with an alternative embodiment of the present invention. The cable 90 comprises sensor wires 91 coiled into a helix. This increases the spatial resolution of the measurements taken. The sensor wires 91 in the fluid sensing zone can be helical to increase the spatial resolution of the measurement (FIG. 11). The wires are moulded or encapsulated in an insulating body to control the fluid contact with the wire. This can be an enamel coating, plastic moulding or any other means of controlling the electrical isolation of the wire from the fluid. The cable can be conveyed to the sensing zone with one or more different cables to allow deployment in complex well constructions (as shown in FIGS. 7 and 8), or simply prevent the system from being sensitive to fluid contacts between the measurement system and the fluid regime of interest. The “conveying cable” is of normal construction of a least two identical cores. There are examples of cables shown in FIGS. 13a, 13b, 14-18.

FIGS. 12a and 12b show the use a ‘windowed measurement’ technique. Data is only taken for selected results, as shown in FIG. 12b since the other peripheral information is not used. Data collection is triggered by the first reflection. Windowing is advantageous because decreasing the period of time or frequency range measured using a window allows the maximum number of samples which can be captured by the memory allocated to the capture circuitry to be concentrated within the window rather than spread out over the entire time or frequency range after the electromagnetic signals are sent, thereby increasing the resolution of the measurement. The resolution can be further increased by providing more memory to the capture circuitry to allow the storage of additional samples. In addition, since the sample rate is high, windowing negates the need to collect large amounts of data that is not be used.

Referring to FIGS. 13a and 13b there is shown a multicore cable 100. The cable 100 is encapsulated in insulating material 106 and includes five sensor wires 101 to 105. At least one of the sensor wires 101 to 105 is “live” and in use has physical contact with any surrounding fluids. The other wires or “non-live” wires are substantially isolated from the surrounding fluids (not shown). The five wires are used as follows, wire 101 is the reference conductor; wire 102 is the live conductor with increased contact with the fluid; wire 103 is ground return; wire 104 is for additional sensors in the installation such as pressure sensors; and wire 105 is also for additional sensors. In alternative embodiments the use of each wire is assigned differently. Outer insulating material 106 is a protective layer which has a groove (not shown) to expose the wire 102. Inner insulating material 107 insulates the sensor wires 101 to 105 from each other.

FIG. 14 shows a cable 10 including wires 110a and 110b with raised beads 111. The beads 11 have larger diameter compared to the wire 110 and provide increased contact with the fluid.

The cable 10 is shown with two wires 110a and 110b, the beads 111 on each wire are staggered to increase the spatial resolution of the cable.

FIG. 15 shows a cable 10 including a wire 112 and bumper wire 113 wound around a former 114. The bumper wire 113 is wound around the former 114 at the same pitch but has a greater diameter and therefore protrudes to provide the wire 112 with mechanical protection. This helps to increase TDR measurement resolution.

FIG. 16A shows a cable 10 with an oval outer profile. FIG. 16B shows a cable 10 with a round outer profile. If the cable is lowered into a reservoir or well on a winch, the cable will need to be inserted into the wellbore through a pressure barrier. The pressure barrier must therefore seal on the outer surface of the cable. It is very difficult to form a pressure seal to static or dynamic (moving) cables having a rectangular or square profile. By providing a cable having an oval or round outer profile, it has been found that the cable can have a high pressure seal ring applied to its outer surface such that the cable provides a pressure barrier at the entry point to the reservoir or well where the fluids are to be measured. Thus the oval and round cable profiles improve the ease with which a cable can pass through pressure barriers. In addition, the cables 10 shown in FIGS. 16A and 16B require the spiralling of conductors for spooling. The oval and round profiles allow the cable to be effectively spooled onto drums whilst also allowing an inline pressure seal to operate on the outer surface. Components of the cable 10 may be constructed from Carbon Fibre. Alternatively components of the cable 10 may be constructed from Kevlar. These materials provide a rigid or semi-rigid cable which can be pushed into a well bore (not shown).

FIG. 17 shows a cable 10 with a square outer profile. The cable 10 has an outer plastic casing 115, a live conductor 116, a groove 117 to increase fluid contact with the live conductor 116 and a reference conductor 118 with no groove. Additional wires 119 are used to communicate with other sensors and provide further depth correlation from a termination at the surface compared to the live and reference wires 116 and 118. In one embodiment the live conductor 116 and reference conductor 118 are straight. In an alternative embodiment the live conductor 116 and reference conductor 118 are helixes.

FIG. 18 shows a perspective view of the cable 10 shown in cross-section in FIG. 20.

FIGS. 19-23 show various interconnections of the surface devices. The cable described above may be used with any of the methods/apparatus described below in order to further improve the accuracy of the measurement of the absolute/relative phase change in the well. FIG. 19 shows the interconnection of the cable 10 with various surface devices. A conductivity measurement circuit 29 and for signal conditioning circuit 30 monitor the cable 10. A time measurement circuit 28 is provided to time the delay between the pulses leaving and a reflection being received back. The time measurement circuit 28 shown in FIG. 19 is a Time Delay Circuit (TDC). The TDC time measurement circuit 28, shown in more detail in FIG. 21, is capable of pico-second time resolution. A commercial TDR measurement 31 is also taken from the cable 10. Electromagnetic radiation is transmitted and reflected along the wires of the cable 10, and the surrounding tubing as a single electromagnetic assembly. The measurement system therefore is implicitly regarded as a combination of the live wire or wire pair and its environment including any tubing or pipe surrounding the cable assembly, and specifically including the fluids contained in this pipe. The reflection or inflection is therefore created by a change in the properties of the complete system at the points along the cable 10 where phase changes occur.

The model developed models the cable assembly, the pipe surrounding it and the fluids in the pipe. The transmission line simulation model uses transmission line theory and a set of mathematical algorithms. The modelling utilised and the characterisation of the cable system uses the principles of transmission line analysis, general circuit modelling, and novel mathematical algorithms to obtain likely behaviour models. By processing the data (and modelling the system) using transmission line theory further information on fluid levels is obtained based on the change in the characteristic impedance of the cable system as the cable passes through the different fluid phases. By using know fluid and cable characteristics and iterating the unknowns in a mathematical model until the model response matches the actual response a further measure of fluid levels in the well bore can be obtained.

In use the reflection from the first wire, which occurs at the point where the first wire is in contact with brine, is typically at an earlier, normally higher, point compared to the reflection from the second wire. Thus the two reflected signals from the two wires do not necessarily travel on identical paths and so the difference between the reflections will typically not only be due to their different amounts of electrical contact with the environment. Nevertheless subtracting the data of the second wire from the first wire still normally improves the overall results. This method is advantageous since it enables determination of the relative and/or absolute position, especially the relative and/or absolute depth, of a phase change. Preferred embodiments of the invention can be used to determine the interfaces between any brine, oil and gas phases. The present system is particularly suited to determining the location of both the gas/oil and oil/brine phase changes in a well bore.

Transmission line theory does not cover the complexity and physical nature of a wire system, and to overcome this problem the transmission line simulation model comprises a set of mathematical algorithms to cope with this. In addition, the response varies not only in amplitude but also in time with reflection and inflection as the pulse passes through the various fluid interfaces. This causes time distortion or stretching and compression of the pulse response. Thus it is preferable that both comparison with simulation models and isolating cable sections (which function as termination resistors) are used to allow for better determination of the relative distortion caused by the fluids. The cable structure can have considerable inductance due to its structure as well as having considerable capacitance from the long lengths of cable used. Thus the response from the cable can be quite complex and have many resonant nodes. Even using a pulse having short rise/fall times will excite many resonant aspects of the cable system and thus create ringing. Although this ringing decays quickly, it still has an impact on the reflection response.

In order to overcome this problem, a model of an electrical circuit (an electrical model) has been developed. The electrical model is electrically equivalent to a cable structure and can be used to accurately model the electrical behaviour of a number of cable structures (including a helical cable structure). The electrical model can be used to generate the expected response of a cable. The expected response can then be deducted from the received response to isolate and effects which are due to a gas/oil or oil/brine phase Change. For example, the ringing that a cable experiences after transmission of a pulse can be modelled. The modelled ringing can then be used to remove resonant aspects of the received signal from the cable system. The aspects of the received signal from the cable system due to a gas/oil or oil/brine phase change will then be more easily extractable. The electrical model can be adjusted to take into account the known properties of the cable system such as the cable length, pipe diameters, conveyance cable properties, as well as the cable's inductance, capacitance, resonant behaviour, etc.

In addition, data from the detected response is used to calibrate the electrical model. The received reflected pulses are passed to the TDR signal conditioning circuit 30 which contains circuitry for filtering out noise and amplifying the received signal. The TDC circuit 28 is a precision timing circuit capable of measuring the precise timing of reflected pulse edges and slopes, and indeed the precise time of the maxima and minima in the reflected traces. The TDC circuit 28 is connected to a microprocessor 27 such that the data obtained from the TDC circuit 28 is available to the microprocessor 27. The received reflected pulses are also passed through a commercial TDR measurement circuit 31. This contains circuitry for recovering the complete reflected pulse waveform (or a windowed subsection of it) and for performing timing and shape analysis on recovered waveforms. The commercial TDR measurement circuit 31 also provides time correction mathematics to correct for propagation velocities and a variety of cable parameters. The data obtained is sent to a microprocessor 27 via a TDR interface 32.

The conductivity measurement circuit 29 is for measuring the resistance of the wires to ground, both local earth and ground return wires, and has a range of settings to cover a variety of resistance ranges. The conductivity measurement circuit 29 is connected to a microprocessor 27 such that the data obtained from the conductivity measurement circuit 29 is available to the microprocessor 27. The resistance measure measures the brine level and is mostly unaffected by the presence of a second fluid above the brine. Since the wire is short-circuited at the brine/oil boundary, the resistance measured will only be that of the wire above the brine. This can then be used to independently calculate the brine/oil boundary.

Determining the position of the brine/oil interface allows calculation of the depth of the oil phase. Electromagnetic signals travelling along any of the wires of the cable will not terminate at the gas/oil interface. Nevertheless, the characteristics of the signal are influenced by the phase change. For example, the speed at which the signal travels on the inner wire (not shown) through the oil and gas phases and is different compared to the outer wire (not shown) since the inner wire is not exposed to the well fluids.

The level of the oil/gas boundary is determined by monitoring the movement of the short circuit termination from either the inner or outer winding wires (not shown) using Time Domain Reflectometry (TDR) and the calculated position of the brine/oil boundary.

Any movement measured is due to the amount of oil changing in the well. Knowing the electrical permittivity of the oil, and the corresponding effects this has due to changes in level, the length of cable immersed in the oil is determined.

The microprocessor processes the various inputs and produces an output indicative of the position of the position of the oil/water boundary in the reservoir. Output from the microprocessor 27 can be sent to an embedded PC 33 for display on a display device 34 or transmission over a telemetry link 35. The embedded PC 33 interfacing with the measuring system providing a human interface, displaying information and communicates with a remote database via the Telemetry Link 35. The display 34 provides the data locally in a graphical and textual display. The Telemetry Link 35 sends information using a serial communications protocol such as Modbus™ via a remote monitoring station (not shown).

FIG. 20 shows the various inputs and outputs to and from the microprocessor 27 and shows a custom designed circuit. The circuit controls the various measurement circuits, performs calculations on data received and outputs information to the embedded PC 33 shown in FIG. 19.

The circuit shown in FIG. 21 performs two measurement functions. It can measure the time between pulses received from the cable to a high resolution and also measures resistance to high resolution.

In FIG. 22, the comparator 29 is capable of pico-second comparisons—The 1st stage amplifier 38 and 2nd stage amplifier 39 are capable of amplifying high frequencies such as video frequencies. Note in the FIG. 20 that the processor can be used to alter comparator levels in the TDC so measurements can be adjusted to suit the fluid condition. More than one measurement can be made from the same circuit by changing the settings for the trigger slopes and detection levels. The relay drive for the resistance measurement allows the processor to alter the resistance range of the resistance measurement and again in the way adapt to the fluid condition present, increasing the accuracy and flexibility over a fixed range device. The circuit detailed in FIG. 22 consists of the two, independent, drive circuits to inject the pulse into each winding of the cable as well as the amplifiers needed to recover the signals from both windings. The drive circuit consists of an ‘AC’ type TTL logic gate. This gate delivers 20 mA of current with fast rise times. The gates are connected in parallel to increase the drive to the necessary 100 mA and to drive a 5 Volt pulse into a 50 Ohm line. The width of the pulse is controlled by the

FIRE lines form the TDC circuit. The signals from the line, including the initial fire pulse, are amplified in a two stage amplifier and fed into the high speed comparator 29 to shape the pulses before being sent to the TDC chip. The amplifiers used are wide band amplifiers given the need to preserve the position of the edges of the pulses returned. The rise time (and fall time) of the pulse is an important consideration. The response of the system is in fact linked to the rise time of the pulse. The reflections and inflections are more pronounced the smaller the rise and fall times (i.e. the faster the pulse changes). If the rise (and fall) time of the pulse is too large (i.e. the pulse changes too slowly) the responses will be lost in the general electrical circuit response. Preferably, the rise and fall times are the smallest rise and fall times that are allowed by the hardware available.

FIG. 23 shows a circuit in which the measurements made and stored in a dual channel time domain reflectometer such as the Megger TDR2000™. The measurements can be stored in the memory of the reflectometer and downloaded remotely but the operation to instigate this recording is done via the keyboard of the reflectometer. The circuit consists of analogue switches, connected across the switch matrix of a Megger TDR2000™. The microprocessor ‘remotely’ presses the necessary keys to record and store a reading. Serial commands are then sent to cause the download of the stored reading. Additionally or alternatively to the TDR measurements, the difference between the resonant response of the first and second wires 15, 17 can be measured. As the first wire 17 is in more direct electrical communication with the surrounding environment that the second wire 15, this difference will relate to the surrounding environment whilst other factors which can influence the frequency response (such as temperature for a non-limiting example) will be same for both the first and second wires 15, 17. Thus, the difference in the complex impedance between first and second wires 15, 17 will normally clearly indicate the levels of fluid in the well bore 60. This analysis uses the fact that the dielectric and conductive properties of the fluid surrounding the cable 10 have a more pronounced affect on one wire than the other, so the difference between the two responses is down to the surrounding fluids and not the general properties of the cable, or any junctions, etc.

The level of brine 24 at the bottom of the well bore and also the amount of oil 23 above the lower fluid can be determined and so the system will determine more than one fluid level. In addition, the level of brine 24 at the bottom of the well bore 60 and also the amount of oil 23 can be determined at the same time. In general the brine 24 around the sensor wires will add both resistive loading and increases dielectric constant to the frequency response, so the resonant peaks are attenuated by the resistive nature of the brine 24 and the capacitance increases. The affect of the oil 23 on the response is to increase the dielectric constant but without the resistive loading seen with brine 24.

An advantage of monitoring both the reflective response and frequency response of the cable 10 is that the results from one can be used to verify and confirm the results from the other. Thus by measuring the resonant frequency the dielectric change around the cable can be determined and by studying the pulse reflection the amount of brine 24 around the cables can be independently determined.

The same inner and outer wires are used for monitoring both the reflective response and frequency response of the cable 10 because the use of the same pair of wires obviates the need to provide multiple sets of wire pairs.

Various experiments were undertaken to test the method in accordance with the present invention. A pulsed electromagnetic signal was sent down cables under various conditions and the amplitude of the reflected signal was monitored as a function of time. The results are shown in FIGS. 24-27. FIG. 24 shows a typical reflection from a salt water contact on a long sensor wire, the low going pulse shows a partial short circuit caused by the brine. In the graph, amplitude is measured in Volts and time is measured in nano seconds. FIG. 25 shows this same reflection moving as the brine level changes on the sensor wire. In this graph, amplitude is measured in Volts and time is measured in seconds. FIG. 26 shows an inflection caused by the higher impedance and capacitive properties of the oil (diesel is used as a test fluid) as they impact the sensor wire in the well. In this graph, amplitude is measured in Volts and time is measured in nano seconds. FIG. 27 shows how an increasing coverage of the sensor wire by Brine causes an increasingly low impedance short to appear with the response changing as shown here. In this graph, amplitude is measured in Volts and time is measured in seconds.

Embodiments of the invention are advantageous in that they enable electromagnetic radiation to be propagated over the full depth of the oil and/or gas reservoir. Monitoring over the full depth produces a more accurate model of the reservoir. If for example the three phases brine, oil and gas are present, then these three phases can be detected.

The information determined can be used to optimise extraction of the fluids, especially the hydrocarbons and may also be used for other purposes such as determining an amount and movement of fluids within the reservoir.

Embodiments of the method can also provide means for constructing a virtual model of the complete length of the well. This model can then be used to plan a more efficient removal of fluids from the well. This can take the form of the response being modelled as a continuous map of the characteristic impedance of the cable system which can then be processed to provide a continuous measure of the fluid properties of fluids surrounding the cable system.

Improvements and modifications may be made without departing from the scope of the invention as defined by the appended claims.

1. A method to determine the relative and/or absolute position of a phase change in a fluid reservoir comprising hydrocarbons, the method comprising the steps of:
(a) providing a first wire in a borehole within said reservoir;
(b) providing a reference system to the first wire in the borehole;
(c) transmitting an electromagnetic signal through the first wire;
(d) detecting a detected response to the electromagnetic signal from the first wire;
(e) generating a reference response from the reference system;
(f) using the reference response to correct the detected response; and
(g) determining the phase change position using data from the corrected response.

2. The method of claim 1, wherein the reference system comprises a second wire also provided in the borehole and wherein the first wire is provided in more direct contact with the surrounding environment than the second wire.

3. The method of claim 2, wherein the method includes the step of transmitting the electromagnetic signal through the second wire and detecting a reference response to the electromagnetic signal from the second wire.

4. The method of claim 2 wherein the first and second wires are combined in a cable, the cable having a first end and a second opposite end, the cable comprising at least the first and second wire, each wire extending from the first to the second end, the first wire being only partially encapsulated within an insulating material such that in use the first wire is in electrical communication with an exposed face of the cable between the first and second ends.

5. The method of claim 4 wherein the cable comprises a third conducting wire providing continuous electrical connection from the first to the second end of the cable.

6. The method of claim 4 wherein at least one of the wires is helically wound.

7. The method of claim 4 wherein the cable is semi-rigid.

8. The method of claim 4 wherein the cable comprises a plurality of terminations for electrically coupling to a wire and at least a first termination has an impedance which is different to a second termination's impedance.

9. The method of claim 1 wherein the reference system comprises a transmission line and an electronic equivalent circuit simulation model.

10. The method of claim 9 wherein the method includes the step of generating the reference response by obtaining an expected response of the wire using the transmission line simulation model.

11. The method of claim 10 wherein the step of correcting the detected response comprises making a numerical correlation between the expected response and the detected response.

12. The method of claim 1 wherein the reference system comprises an electrical model of the first wire and borehole.

13. The method of claim 12 wherein the method includes the step of generating the reference response by producing a predicted response of the first wire and borehole based on known properties of the first wire and borehole.

14. The method of claim 12 wherein the electrical model is generated by providing a model of a circuit which is electrically equivalent to the wire and borehole.

15. The method of any-preceding claim 11 wherein the electromagnetic signal is an electromagnetic pulse which is transmitted a first end of the cable and the response is detected at the first end of the cable as a reflection of the electromagnetic pulse.

16. The method of claim 1 wherein transmitting the electromagnetic signal through the wire comprises creating a resonant circuit comprising the wire and detecting the response comprise measuring the resonant circuit's frequency response.

17. The method of claim 1 the step of determining the response comprises determining the response of a section of a plurality of sections of wire forming the wire.

18. The method of claim 1 wherein the method further comprises determining the response of the wire with a termination electrically coupled to the wire and including the steps:
(a) providing a first termination and a second termination;
(b) determining the relative and/or absolute position of a phase change in a fluid reservoir comprising hydrocarbons with the first termination electrically coupled to the wire; and
(c) determining the relative and/or absolute position of a phase change in a fluid reservoir comprising hydrocarbons with the second termination electrically coupled to the wire.

19. An apparatus for determining the relative and/or absolute position of a phase change in a hydrocarbon reservoir, the apparatus comprising a first wire; an electromagnetic pulse generator; a detector for detecting an electromagnetic pulse; a reference signal generator; and processing means for comparing a detected signal with a reference signal and determining a position of a phase change.

20. The apparatus of claim 19 wherein the reference signal generator is a second wire through which an electromagnetic pulse is also passed.

21. The apparatus of claim 19 wherein the reference signal generator is a transmission line and an electronic equivalent circuit simulation model.

22. The apparatus of claim 19 wherein the reference signal generator is an electrical model of the first wire in a borehole.

23. The apparatus of claim 20 wherein the first and second wires are in a cable and wherein the first wire is provided in more direct electrical communication with a surrounding environment compared to the second wire.
